(19) United States
(12) Patent Application Publication
(10) Pub. No.: US 2012/0237681 A1
(43) Pub. Date: Sep. 20, 2012

(54) SYSTEM AND METHOD OF DEPICTING FOLIAGE

(76) Inventors: Larry Pickens, Rock Cave, WV (US); Rebecca Pickens, Rock Cave, WV (US); Kenneth Fitzgerald, Rock Cave, WV (US); Linda Fitzgerald, Rock Cave, WV (US); Thomas Davis, Belington, WV (US)

(21) Appl. No.: 13/050,318

(22) Filed: Mar. 17, 2011

(51) Int. Cl. B05D 1/32; B05B 15/04; B05C 1/00

(52) U.S. Cl. 427/282; 118/505; 118/301; 118/200

(57) ABSTRACT

A system and method for creating and replicating foliage patterns comprising: a first stencil, where the first stencil forms the shape of a leaf; and a second stencil, where the second stencil forms the shape of an arrangement of veins and stems of a leaf, wherein a user may selectively arrange and attach the first and second stencil to create a foliage pattern. The leaf may include either an oak leaf or a maple leaf. The user may selectively apply at least one paint color to the stencils to create a depiction of the foliage pattern. In one particular embodiment, the system may comprise a layer of clear coat paint or sealant over the painted surface in order to protect the appearance of the pattern of foliage.

### I. FIELD OF THE INVENTION

The present invention generally relates to the depiction of foliage, and more specifically to a system and method of creating a depiction of foliage.

### II. MOTIVATION FOR THE INVENTION

Persons engaged in outdoor activities may often choose to adorn themselves in articles of clothing and equip themselves with tools and effects that simulate the appearance of the outdoor environment. This is done in order to have a person and his or her articles and effects “blend in” with the appearance of the environment such that they do not stand out against the environment and may in fact conceal themselves in the environment. Hunters and birdwatchers, for example, may prefer to blend in to the environment while undertaking their respective sporting pursuits.

To achieve such a concealment, a person may adorn him or herself with clothing that has a foliage pattern printed thereon. The person may also attach a material or finish to his or her articles with a pattern printed thereon, in order to conceal the articles. (For instance, a hunter or birdwatcher may employ binoculars, the casing of which is covered in a camouflage pattern).

Such clothing, materials, and finishes have a number of drawbacks, however. For instance, the pattern provided thereon is fixed and thus can only effectively replicate one type of environment. Thus, if a person is wearing a jacket, for example, that includes a pattern of oak leaves, he or she may not effectively conceal him or herself with that jacket in a forest of birch trees. Thus, multiple articles of clothing (with different patterns) would be required to allow a person to conceal him or herself in a variety of environments, which causes increased expenses to the person. Alternatively, clothing may feature a hybrid pattern (a pattern with a variety of environments depicted thereon), which hybrid pattern makes the detrimental sacrifice of not fully depicting one type of foliage in exchange for attempting to increase the adaptability of the clothing or article.

Furthermore, existing pre-constructed clothing and articles do not allow person to customize such clothing or articles to depict a selected environment, thus requiring the person to search the market (often times, unsuccessfully) for the clothing or article that best depicts a particular environment.

Additionally, creating a pattern of foliage on clothing or an article is not an easy task using methods and systems known in the art. For a person that does not necessarily possess artistic faculties, it may be difficult if not impossible to recreate a lifelike foliage pattern by hand-painting or spray painting the pattern on clothing or an article.

Accordingly, there persists a need for a system and method for creating and replicating a foliage pattern on clothing and other articles that is easy to use and results in lifelike and accurate depictions of natural foliage.

Accordingly, it is an object of the present invention to obviate the above and other disadvantages from existing art and to provide for a system and method for creating and replicating a foliage pattern on clothing and other articles.

It is further an object of the present invention to provide a cost-effective system and method that allows a person to create and replicate a plurality foliage patterns accurately and quickly.

Furthermore, it is an object of the present invitation to provide a system and method that allows a person to create and replicate the foliage pattern of a variety of plants, trees, and other flora.

### III. SUMMARY OF THE INVENTION

The present invention relates to a system and method for creating and replicating foliage patterns comprising: a first stencil, where the first stencil forms the shape of a leaf and a second stencil, where the second stencil forms the shape of an arrangement of veins and stems of a leaf, wherein a user may selectively arrange and attach the first and second stencil to create a foliage pattern. The leaf may include either an oak leaf or a maple leaf. The user may selectively apply at least one paint color to the stencils to create a depiction of the foliage pattern. In one particular embodiment, the system may comprise a layer of clear coat paint or sealant over the painted surface in order to protect the appearance of the pattern of foliage.

### IV. DESCRIPTION OF THE DRAWING

The advantages and features of the present invitation will become better understood with reference to the detailed description taken in conjunction with the accompanying drawings, in which:

FIG. 1 depicts a perspective view of a stencil of the disclosed system and method, in accordance with an exemplary embodiment of the present invention; and

FIG. 2 depicts a first exemplary pattern of foliage disposed on an item and created by a plurality of stencils, in accordance with an exemplary embodiment of the present invention.

FIG. 3 depicts a second exemplary pattern of foliage disposed on an item and created by a plurality of stencils, in accordance with an exemplary embodiment of the present invention.

### V. DESCRIPTION OF THE INVENTION

The present invention provides a system and method of creating and replicating foliage patterns for disposition on articles, such as clothing and outdoor equipment. The system and method comprise at least one stencil that may be in the shape of at least one piece of foliage. Presumably, the stencil may be comprised of a pliable plastic material that permits flexibility of the stencil during use.

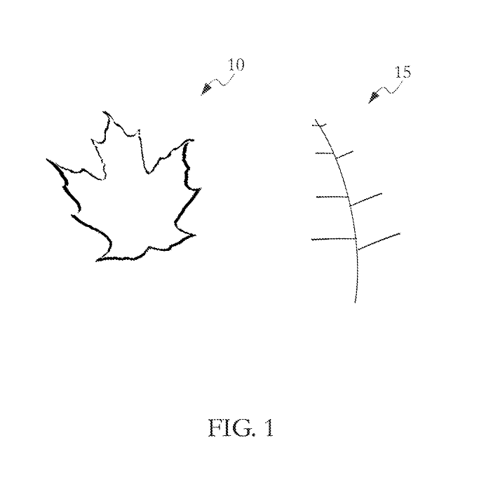

In a preferred embodiment of the present invention, a first stencil 10 and a second stencil 15 are provided as shown in FIG. 1. The first stencil 10 forms the shape of a leaf such as an oak leaf or a maple leaf. Further the second stencil 15 forms the shape of an arrangement of veins and stems of a leaf. A user may selectively arrange and attach the first stencil 10 and second stencil 15 or a plurality of first and second stencils 10, 15 on a surface of an article of clothing or equipment. The arrangement of stencils may be at the user's preference and may be in a form to simulate a pattern of actual foliage. The user may then selectively apply at least one paint color to the stencils to create a depiction of a pattern of foliage on the article of clothing or equipment. In one exemplary embodiment, the user may thereafter apply a layer of “clear coat” paint or sealant over the painted surface in order to protect the appearance of the pattern of foliage that has been created on the article of clothing or the equipment.

In another exemplary of the present invention, the user may apply the paint to the stencils with an airbrush. It will be apparent that the user may also apply paint to the stencils using a horse hair or synthetic hair paintbrush, an aerosol spray, or other similar paint application techniques.

In another embodiment of the present invention, a method for creating a camouflage pattern is provided. The method may comprise the arrangement and attachment of at least one stencil to a surface, the application of at least one color of paint to the stencil arrangement, and, optionally, the application of a clear coat sealant to the painted surface.

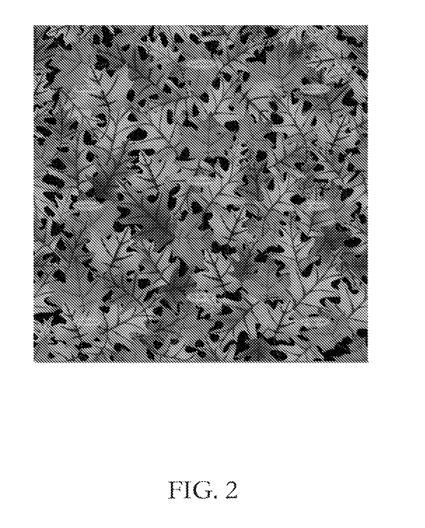

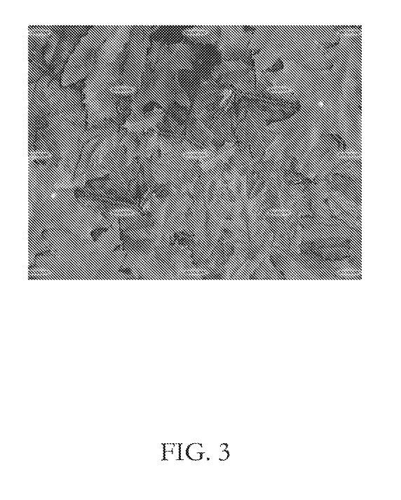

FIG. 2 depicts a first exemplary pattern of foliage disposed on an item by using the stencils in accordance with the present invention. The first exemplary pattern may be created by using any of the various above listed painting techniques. FIG. 3 depicts a second exemplary pattern of foliage disposed on an item, where the second exemplary pattern may be created by any of the above-mentioned painting techniques.

The present invention offers various advantages. Persons engaged in outdoor activities may create and replicate foliage patterns of actual plants, trees, and other fauna. These patterns may be made in a variety of color schemes in order to replicate the changes in seasonal appearances of a particular foliage. The variety of configurations of the stencils of the present invention further permit a user to replicate a plurality of different plant and fauna shapes and appearances. The stencil and application method of the present invention facilitate ease of creation and replication of foliage patters, even for persons otherwise lacking in artistic abilities. The stem stencil facilitates the appearance of depth of the depicted foliage to achieve a more realistic appearance.

Furthermore, the stencil and application method of the present disclosure allow a user to recreate a customizable appearance of a camouflage or foliage pattern according to his or her preferences or environmental requirements. The stencil of the present disclosure further permits low production cost.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for creating and replicating foliage patterns comprising:
a. a first stencil, where the first stencil forms the shape of a leaf; and
b. a second stencil, where the second stencil forms the shape of an arrangement of veins and stems of a leaf, wherein a user may selectively arrange and attach the first and second stencil to create a foliage pattern.

2. The system according to claim 1, where the leaf includes at least one of an oak leaf and a maple leaf.

3. The system according to claim 1, where the user selectively applies at least one paint color to the stencils to create a depiction of the foliage pattern.

4. The system according to claim 1, further comprising a layer of clear coat paint or sealant over the painted surface in order to protect the appearance of the pattern of foliage.

5. The system according to claim 3, where the user applies the paint with an airbrush.

6. The system according to claim 3, where the user applies the paint with at least one of a horsehair brush, a synthetic hair brush and an aerosol spray.

7. The system according to claim 1, where the foliage pattern includes an appearance of depth.

8. A method of creating and replicating foliage patterns comprising the steps of:
a. forming a stencil arrangement with a first stencil and a second stencil;
b. attaching the first stencil and second stencil to a surface;
c. applying at least one color of paint to the stencil arrangement; and
d. applying a clear coat sealant to the painted surface.

9. The method according to claim 8, further comprising the step of creating foliage pattern of plants and trees.
